(19) United States
(12) Patent Application Publication
(10) Pub. No.: US 2015/0074116 A1
(43) Pub. Date: Mar. 12, 2015

(54) INDEXING ATTACHABLE APPLICATIONS FOR COMPUTING SYSTEMS

(71) Applicant: CloudVolumes, Inc., Santa Clara, CA (US)

(72) Inventor: Fei Huang, Fremont, CA (US)

(21) Appl. No.: 14/482,029

(22) Filed: Sep. 10, 2014

Related U.S. Application Data
(60) Provisional application No. 61/875,976, filed on Sep. 10, 2013.

(51) Int. Cl. G06F 17/30; G06F 9/455

(52) U.S. Cl. CPC G06F 17/30312; G06F 9/45533
USPC 707/741

(57) ABSTRACT

Examples disclosed herein provide systems, methods, and software for indexing attachable applications for computing systems. In one example, a method of attaching an application to a computing system includes identifying an application attach triggering event for the computing system. The method further includes, identifying a storage location for the application based on the application attach triggering event and an application index, and attaching at least one storage volume to the computing system corresponding to the storage location.

### RELATED APPLICATIONS

This application is related to and claims priority to U.S. Provisional Patent Application No. 61/875,976, entitled “INDEXING FOR ATTACHED APPLICATIONS,” filed on Sep. 10, 2013, and which is hereby incorporated by reference in its entirety.

### TECHNICAL BACKGROUND

Computing systems often require various applications to accomplish desired tasks, such as productivity applications, image and video editing application, gaming applications, amongst a variety of other similar applications. To make the applications available on the computing systems, installers may be used that assist in generating installation files and directories that are necessary for the application to execute. In some examples, installers may check for existing versions of the software, create or update program files and directories, and modify the registry or other configuration files, amongst other installation tasks. Accordingly, the process of installing an application may take both time and resources from the computing system and the operating personnel.

In further examples, new computing devices or recently provisioned virtual machines may require the installation of a plurality of applications. These applications may be located on storage disks, the internet, install media, such as a compact disk, or any other installable location. Consequently, if a user or administrator desires to install all of the applications, time and resources may be taken away from executing the application to identify the location and complete the installation process.

### OVERVIEW

Examples disclosed herein provide systems, methods, and software for indexing attachable applications for computing systems. In one example, a method of attaching an application to a computing system includes identifying an application attach triggering event for the computing system. The method further includes, identifying a storage location for the application based on the application attach triggering event and an application index, and attaching at least one storage volume to the computing system corresponding to the storage location.

In another instance, a computer apparatus to attach an application to an attachable computing system includes processing instructions that direct a computing system to identify an application attach triggering event for the attachable computing system. The processing instructions further direct the computing system to identify a storage location for the application based on the application attach triggering even and an application index, and attach at least one storage volume to the attachable computing system corresponding to the storage location. The computer apparatus further includes one or more non-transitory computer readable media that store the processing instructions.

In a further example, a computer apparatus to manage an application index includes processing instructions that direct a computing system to identify one or more applications stored in one or more attachable storage volumes. The processing instructions further direct the computing system to identify storage locations for the one or more applications stored in the one or more attachable storage volumes, and generate the application index. The computer apparatus further includes one or more non-transitory computer readable media that store the processing instructions.

### BRIEF DESCRIPTION OF THE DRAWINGS

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 illustrates a computing environment.

FIG. 2 illustrates a method of attaching an application to a computing system.

FIG. 3 illustrates an application index for attachable applications.

FIG. 4 illustrates a computing environment to attach indexed applications.

FIG. 5 illustrates a computing environment to attach indexed applications.

FIG. 6 illustrates an overview of attaching indexed applications to computing systems.

FIG. 7 illustrates an overview of attaching indexed applications to computing systems.

FIG. 8 illustrates a computing system for attaching applications.

FIG. 9 illustrates a computing system for generating an application index.

### DETAILED DESCRIPTION

Computing systems may require the installation of one or more applications to accomplish specific tasks, such as word processing, image editing, gaming, or other similar tasks. The installations of these applications can be both time consuming and waste valuable computing resources, as the files may need to be uncompressed, generated, and placed in an appropriate location in the file system. To assist in providing the necessary applications, applications can be installed ahead of time on attachable storage volumes so as to avoid the installation on each computing system. Thus, if a computing system requires an application, the volume containing the application can be attached or mounted, and registry keys and other files within the computing system can be modified to make the application executable. This process may apply similarly to both physical computing systems, such as desktop computers and servers, as well virtual computing systems and virtual machines.

A virtual machine is a virtualized copy of a computer system, with virtual hardware that includes a disk controller, a network card, and other virtual hardware. Frequently, running within the virtual machine is a full operating system, such as Linux or Microsoft Windows. These virtual machines execute on a physical host server with a hypervisor that abstracts the physical hardware of the host server so that the virtual machine sees virtual hardware regardless of what the underlying hardware actually comprises.

Storage for the virtual machine can come from a variety of sources including physical devices directly mapped to the virtual machine, SAN connected by iSCSI or Fibre Channel, or files containing virtual disks. In some instances, the storage attached to the virtual machines may include applications that are capable of execution on the virtual machine. To make these applications available, an application attach triggering event is identified, allowing the hypervisor to attach the volume. Upon being attached, the registry keys and other file system elements within the virtual machine may be updated to make the application executable as though it is locally installed.

Here, to make the applications available within the physical and virtual computing systems, an application index is provided. This application index associates application identifiers, such as application names, to a storage location capable of being attached to the computing system. For example, if a user or process requested a word processing application to be attached to a computing system, the application index may identify one or more volumes storing the application, and initiate the attachment of the one or more volumes to the computing system. In some examples, the requester of the application may be the user of the computing system. Accordingly, an agent, which may comprise a process, daemon, or other software module on the computing system may identify the location of storage volume or volumes required for the application, and initiate the attachment of the storage. In other instances, an administrator or other management process may select the applications to be attached to a computing system. Responsive to the administrator or management process selecting an application, the application index may be used to identify the location of the application within one or more storage volumes, and initiate the attachment of the application to the computing system.

Once the volume or volumes for an application are attached to the computing system, registry keys, files, and other file system elements may be updated to make the application available for execution. In some examples, in making the application available, the files, directories, and other elements necessary for the application may be overlaid into the file system of the computing device. Thus, instead of seeing each application volume that is attached for applications on the computing system, the applications may appear as though they have been installed locally in the Program Files or other similar storage locations.

In some examples, one or more virtual machines may be instantiated on a host computing system as a part of a service. This service may allocate the virtual machines to one or more users, allowing the users to select particular applications that suit the users' preferences and requirements. To access the one or more virtual machines, remote computing devices, such as desktop computers, laptop computers, smart phones, tablets, and the like, may remotely login or access the virtual machines using the internet or other similar communication network. Once a virtual machine is accessed by a remote computing device, a user at the remote computing device may select one or more applications to attach to the virtual machine using the virtual desktop or other similar interface provided by the service. In response to the application selections, storage locations for the applications may be determined based on an application index available from the virtual machine. The storage volumes corresponding to the storage locations may then be attached or mounted to the virtual machine, and the applications stored thereon made available by modifying registry keys and other settings on the virtual machine. Further, once the user logs off the virtual machine, the application volumes may be detached from the virtual machine, preventing future execution while the user is not remotely accessing the machine.

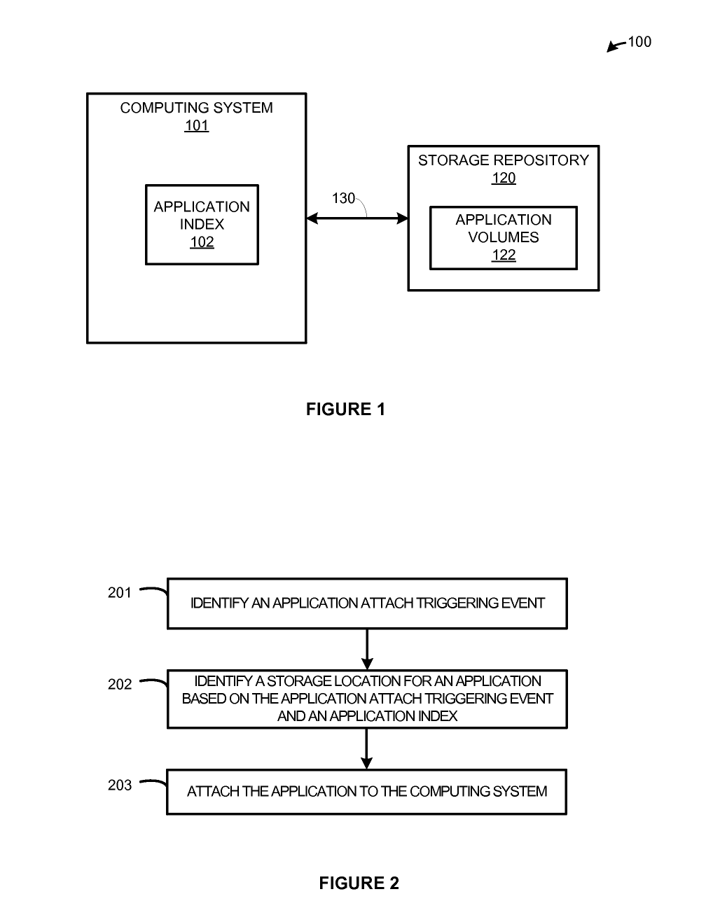

To further illustrate the use of an application index to identify application storage locations, FIG. 1 is provided. FIG. 1 illustrates a computing environment 100 to attach indexed applications. Computing environment 100 includes computing system 101 and storage repository 120. Computing system 101 further includes application index 102, and storage repository 120 further includes application volumes 122. Computing system 101 communicates with storage repository 120 over communication link 130. Computing system 101 may represent a server computer, a desktop computer, a cell phone, or other similar physical computing machine. Alternatively, computing system 101 may represent virtual computing system, such as a virtual machine, which executes on a host computing system.

In operation, computing system 101 may require a new application that is not currently available to execute. Instead of installing the application, which takes both time and resources, computing system 101 may look to application volumes 122 for the appropriate application. Application volumes 122 contain one or more applications that are capable of immediate execution upon attachment to computing system 101. To identify the appropriate application, computing system 101 may use application index 102. Application index 102 is capable of quickly identifying the requested application and associating that application to a storage location within application volumes 122. After this association, the volume may be attached to computing system 101, and registry keys, files, and other elements may be updated within computing system 101 to make the application available for execution.

To further illustrate the operation of computing environment 100, FIG. 2 is provided. FIG. 2 illustrates a method of attaching an application to a computing system according to one example. The method includes identifying an application attach triggering event (201). An application attach triggering event may include a user selection of an application to attach, a process on the computing system requiring the attachment of an application, an external request to attach an application to the computing system, or any other request for an application. In response to the application attach triggering event, the method includes identifying a storage location for an application based on the application attach triggering event and an application index 106 (202). The storage location may include any location capable of being attached by computing system 101 or a hypervisor, such as any application volume from application volumes 122 in storage repository 120. Specifically, in some examples, the application index may identify both the volume on which the application files and directories are located, as well as the location within that volume that the application files and directories are located. Application index 106 may include a table, linked list, or some other data structure capable of identifying the storage location of the application. Based on the storage location identified by the application attach triggering event and application index 106, the application is attached to computing system 101 (203).

In some examples, the attaching of the application may include mounting the application to the computing system. Once mounted to the physical or virtual computing system, the registry keys, files, and other elements may be updated on the system to reflect the additional application. This may include, in some instances, overlaying the application and making the application appear within the program files or other similar application folder within the computing system. Accordingly, once the volume is attached to the computing system, the requested application may become executable without following a traditional installer for the application.

Returning to the elements FIG. 1, computing system 101 may represent a physical machine, which may include communication interfaces, network interfaces, processing systems, computer systems, microprocessors, storage systems, storage media, or some other processing devices or software systems, and can be distributed among multiple devices. Computing system 101 may include software such as an operating system, logs, databases, utilities, drivers, caching software, networking software, and other software stored on a computer-readable medium. Alternatively, computing system 101 may represent a virtual machine that is capable of execution on a physical machine. A virtual machine may abstract the hardware of the physical machine, and execute via a hypervisor on the physical machine.

Storage repository 120 includes application volumes 122 that store one or more applications. Although illustrated separately, it should be understood that storage repository 120 might reside in whole or in part on computing system 101. Storage repository 120 may include volatile and nonvolatile, removable and non-removable media implemented in any method or technology for storage of information, such as computer readable instructions, data structures, program modules, or other data. Storage repository 120 can be implemented as a single storage device, but may also be implemented across multiple storage devices or sub-systems.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired applications, as well as any combination or variation thereof, or any other type of storage media. In some examples, storage repository 120 may comprise physical devices such as hard disks or other similar media, SAN connected by iSCSI or Fibre Channel, and files containing virtual disks.

Communication link 130 may use metal, glass, optical, air, space, or some other material as the transport media. Communication link 130 may use various communication protocols, such as Internet Small Computer Interface (iSCSI), Fibre Channel, Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format, including combinations, improvements, or variations thereof.

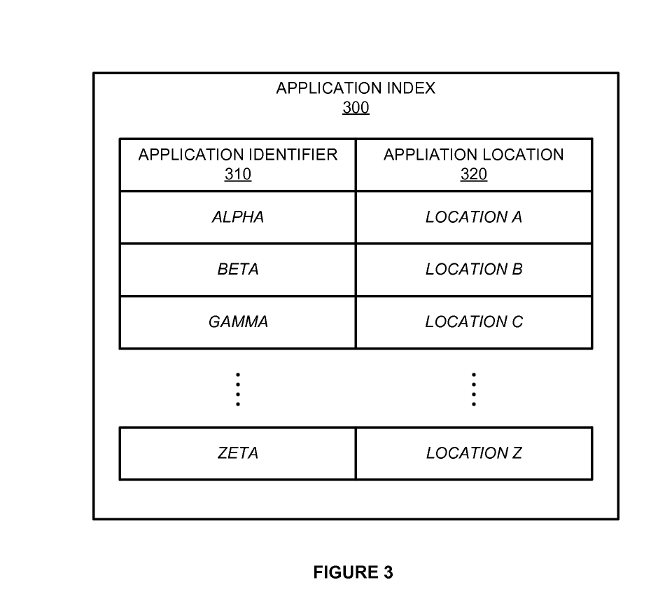

FIG. 3 illustrates an application index 300 according to one example. Application index 300 is an example of application index 102, although other examples may exist. Application index 300 includes application identifier 310 and application location 320. Application identifier 310 is the identity of an application based on the application attach triggering event, and application location 320 is the location of the application in the storage repository.

In operation, an application attach triggering event will occur, such as a user requesting an application or some other attach triggering event. Following the triggering event, the computing system will attempt to attach the appropriate volume with the application to make the application executable. To accomplish this task, the computing system may have access to an application index, such as application index 300. Application index 300 allows the computing system to match the requested application from the triggering event to the location within the storage volumes. Once the location has been determined from application index 300, the computing system will attach the appropriate identified volume.

Although illustrated as a data table in the present instance, it should be understood that the application index 300 could comprise any data structure, such as an array, tree, or any other type of data structure. Further, application index 300 may be implemented in the computing system by storing the index at any time during the operation of the computing system. Application index 300 may also be updated every time the computing system starts, at periodic intervals during the operation of the computing system, or at any other time.

In some examples, an administrator or management process that has control over the attachable storage volumes may create application index 300 for one or more computing systems. In other examples, application index 300 is maintained automatically as applications are stored in the attachable volumes. In still other instances, application index 300 is updated based on user requests for software stored in the storage volumes, such that the next request for the software will be included within the application index.

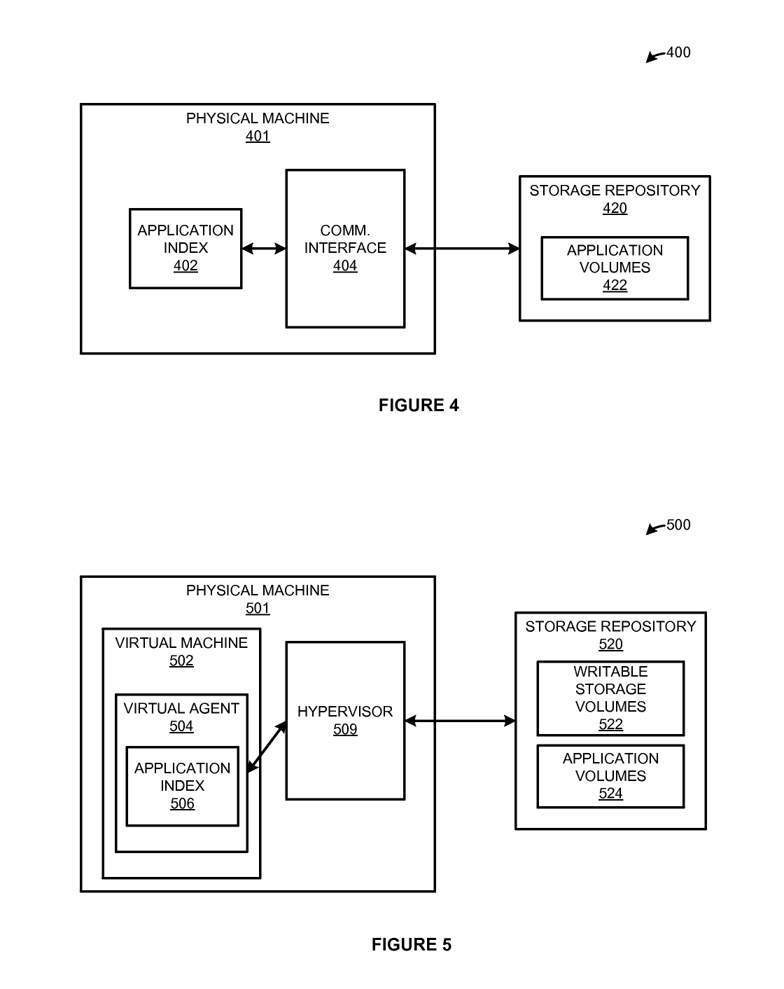

FIG. 4 illustrates a computing environment 400 according to one example. Computing environment 400 includes physical machine 401 and storage repository 420. Physical machine 401 includes application index 402 and communication interface 404, and storage repository 420 further includes application volumes 422. Physical machine 401 is an example of computing system 101, although other examples exist. Physical machine 401 is an example of any physical computing system such as a server computer, a desktop computer, a smart telephone, or some other computing system.

In operation, physical machine 401 identifies an application attach triggering event, which may include a user request for an application, a process request on physical machine 401 for an application, an external request for an application, among other attach triggering events. Upon the detection of the triggering event, application index 402 may associate the request to an appropriate storage volume that contains the application. Once directed to the appropriate storage volume, the storage volume may then be attached from application volumes 422. In some examples, once the appropriate application files are attached to physical machine 401, the application may become instantly executable.

To generate application volumes 422, an administrator or some other process may install the applications in volumes accessible by one or more computing systems. These installations allow a single install to be accessible by more than one computing system at any one time. For instance, two computing systems may each require a word processing application. To make the application available, the same storage volume may be attached to each of the computing systems allowing read access to the necessary files for the application.

While the applications are installed within the application volumes, an application index is created and maintained to assist systems, such as physical machine 401, in identifying the appropriate storage location for the application. For instance, if a productivity suite were installed in application volumes 422, application index 402 may maintain a location record for each of the applications within the suite. Accordingly, when physical machine 401 or some other computing system requires access to a particular application within the suite, application index 402 may be used to quickly identify the attachable volume or volumes.

Although illustrated in the present example as being internal to physical machine 401, it should be understood that application index 402 might be implemented in external computing systems. For example, an administration system may include the application index to allow an administrator or some other automated process to define applications to be attached to the computing system. Thus, a command may be transferred from the administration system to the physical machine to attach one or more volumes related to a particular application or set of applications.

FIG. 5 illustrates a computing environment 500 according to another example. Computing environment 500 includes physical machine 501 that communicates with storage repository 520. Physical machine 501 further includes virtual machine 502, virtual agent 504, application index 506, and hypervisor 509. Storage repository 520 further includes writable storage volumes 522 and application volumes 524. Virtual machine 502 is an example of computing system 101, although other examples exist.

In operation, hypervisor 509 will operate on physical machine 501 to facilitate the execution of virtual machines, such as virtual machine 502. Physical machine 501, sometimes referred to as a host machine, may include one or more hypervisors to execute one or more virtual machines, concurrently. As illustrated in virtual system 500, virtual machine 502 includes virtual agent 504 that is used to communicate with hypervisor 509. Virtual agent 504 is responsible for identifying application attach triggering events, such as a user selection of an application, and notifying hypervisor 509, to attach the appropriate storage volume containing the application. Once hypervisor 509 attaches the appropriate volumes to virtual machine 501, virtual agent 504 or an overlay agent may modify the registry keys and other elements to enable the execution of the application on the virtual machine. In some examples, the application may appear as though it has been installed on a drive within the virtual machine, but in reality is executing via the attached volume.

Although illustrated within virtual machine 502, application index 506 may reside wholly or partially outside of virtual machine 502 in a virtual manager that works with hypervisor 509, or in hypervisor 509 itself. Further, in some examples, application index 506 may be located on an administration computing system capable of configuring one or more virtual machines, including virtual machine 502. Accordingly, when an administrator or some other process identifies an application to attach, the index within the administration system can assist in the attachment of the appropriate volume to one or more virtual machines, including virtual machine 502.

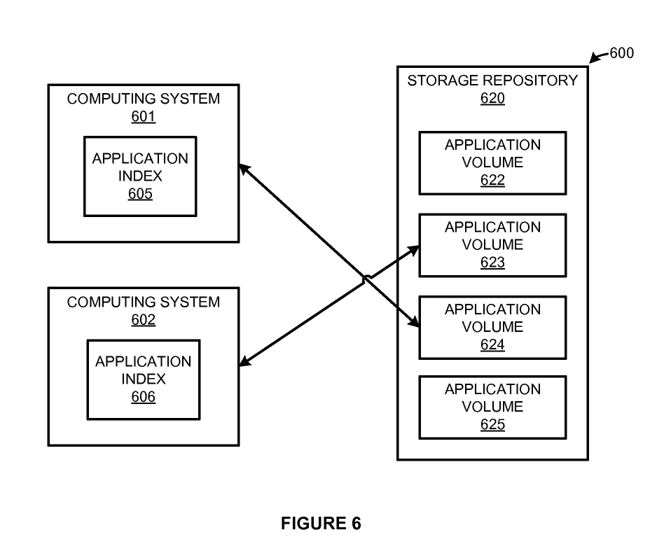

FIG. 6 illustrates an overview for attaching indexed applications. Overview 600 includes computing systems 601-602, which may comprise physical or virtual computing devices, and storage repository 620. Each computing system 601-602 further includes one of application indexes 605-606, and storage repository 620 further includes application volumes 622-625 that store applications capable of execution on computing systems 601-602.

In operation, an administrator or some other management system may provision storage repository 620 to allow computing systems, such as computing systems 601-602, to attach applications when they are required. These applications may include productivity applications, image or video editing application, gaming applications, amongst a variety of other applications. As computing systems 601-602 execute, a user or process executing on the machine may identify that an application is required. This application requirement, identified as an application attach triggering event, requires computing systems 601-602 to use application indexes 605-606.

Application indexes 605-606 comprise pre-generated data structures that allow computing systems 601-602 to identify the storage locations of required applications. These indexes may be transferred to the computing systems by an administration system, and may further be periodically updated in the computing system as applications are added or removed from storage repository 620. Once an application attach triggering event is identified and an application location is determined based on the application index, the appropriate application volume is attached using the location provided by the index. For example, as illustrated in FIG. 6, computing system 601 requires the attachment of application volume 624, whereas computing system 602 requires the attachment of application volume 623. Once the application volumes are attached or mounted to the computing systems, the applications may be made available by overlaying the application elements within the systems.

Although illustrated as internal in the present example, it should be understood that application indexes 605-606 might exist on an administration system capable of initiating the attachment of particular applications for the computing systems. Further, it should also be understood that application indexes 605-606 might comprise the same data structure in some examples that is provided by the administration system.

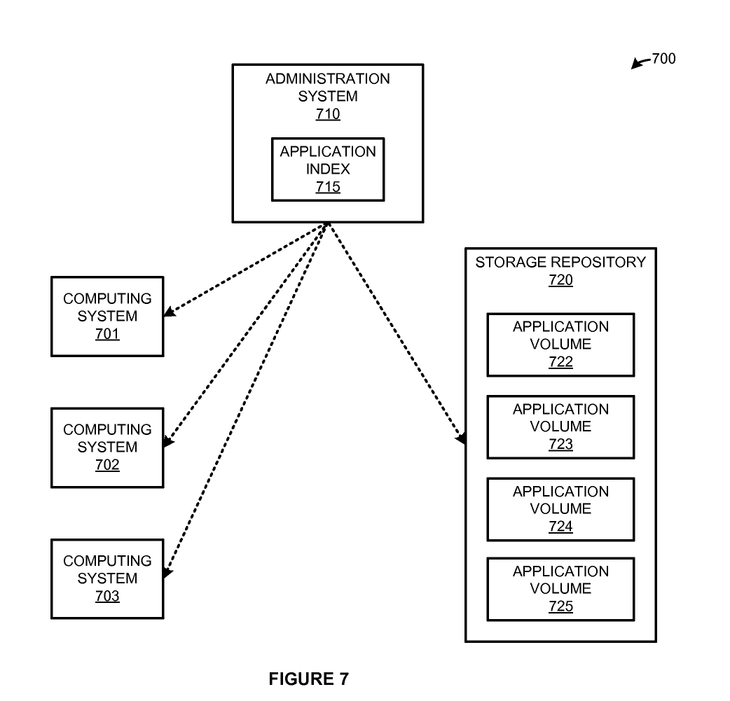

To further illustrate an example of applying an application index, FIG. 7 is included. FIG. 7 illustrates an overview 700 of attaching indexed applications to computing systems. Overview 700 includes computing systems 701-703, administration system 710, and storage repository 720. Administration system 710 further includes application index 715, and storage repository 720 further includes application volumes 722-725. Computing systems 701-703 may comprise physical computing systems, such as servers or desktop computers, and may further comprise virtual computing systems or virtual machines.

In operation, computing systems 701-703 may require various applications to perform desired tasks. To provide the applications, administration system 710 is included that allows an administrator or other management process to dictate the applications that are supplied to computing systems 701-703. For example, administration system 710 may identify that a particular application is required to be attached to all computing systems 701-703. In response to identifying the application, administration system 710 checks application index 715 to identify a location for the application. The application may exist on a single application volume in application volumes 722-725 or may exist on a plurality of application volumes. Once the location of the application is identified, such as a path to the storage volume and folder within the storage volume, administration system 710 may initiate the attachment of the application volume to computing systems 701-703. In some instances, once the application volume is attached, the application files and directories are made available for execution by overlaying the files, directories, and other elements for the application within the file system of each computing system.

Although not illustrated in the present example, administration system 710 may be used to generate application index 715 based on the applications within storage repository 720. For instance, administration system 710 may generate an initial application index for all applications in storage repository 720, then update the application index as applications are added or removed from storage repository 720. Accordingly, administration system 710 may be configured to maintain an up-to-date version of the application index that corresponds to the applications available to the computing system. In some examples, when the application index is provided to each computing system individually, the administration system may be used to periodically update the application index to reflect the current state of storage repository 720. For example, an application may be added to application volumes 722-725. Responsively, application index 715 may be updated to reflect the new application, and may be forwarded to computing systems 701-703 to allow the applications to identify and attach the appropriate location for the application.

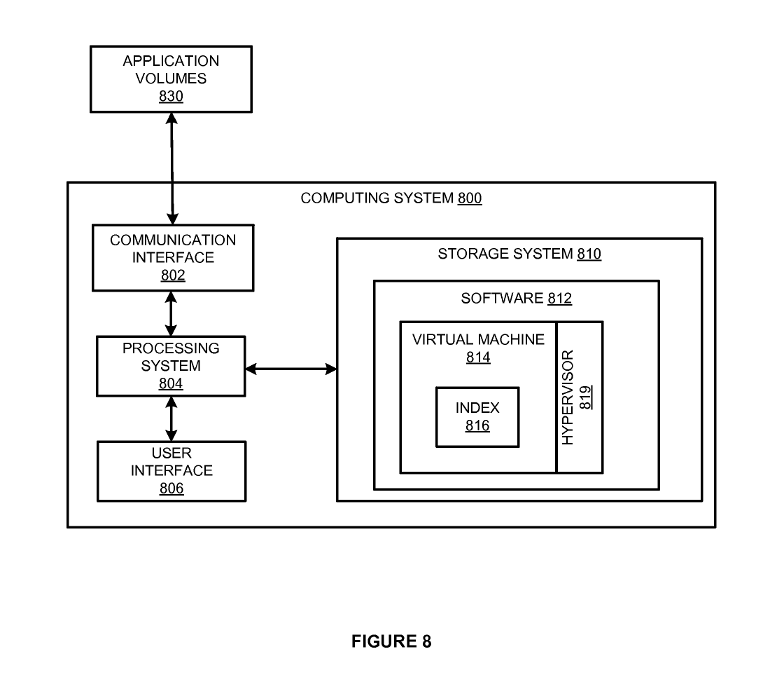

FIG. 8 illustrates a computing system 800 for attaching applications using an application index. Computing system 800 is an example of computing system 101, although other examples are possible. Computing system 800 includes communication interface 802, processing system 804, user interface 806, storage system 810, and software 812. Processing system 804 loads and executes software 812 from storage system 810. Software 812 includes virtual machine 814, which is capable of operating on computing system 800. Software 812 may further include an operating system, utilities, drivers, network interfaces, applications, or some other type of software. When executed by computing system 800, software 812 directs processing system 804 to attach an application to virtual machine 814 as described herein.

In a particular example, virtual machine 814 will execute on computing system 800. Virtual machine 814 is a virtualized copy of a computing system with virtual hardware, such as a disk controller, a network controller, and other virtual computing hardware. Virtual machine 814 executes on hypervisor 819 that abstracts the physical hardware of the host server, in this case computing system 800, so that the virtual machine sees virtual hardware regardless of what the underlying hardware of computing system 800 actually comprises.

In operation, a user or some other process identifies that virtual machine 814 requires an application. To make the application available, one or more application volumes 830 are available to the virtual machine that contain the required applications. Thus, instead of installing the application, the application may be attached from application volumes 830 and become available for execution upon attachment.

Once the user or process determines that a new application needs to be added to virtual machine 814, virtual machine 814 uses index 816 to identify the appropriate location, such as the volume and file within the volume of the application. Index 816 is an example of application index 102, although index 816 may take other forms. Upon the identification of the location, the appropriate application volume is then attached using hypervisor 819, and registry keys and other files are modified to make the application available to virtual machine 814.

Although illustrated within virtual machine 814, it should be understood that index 816 might reside anywhere in software 812. By residing as a software module within software 812, index 816 could allow application volumes 830 to be attached to computing system 800, directly. Further, applications within application volumes 830 could be attached to computing system 800 such that they are executable within computing system 800 without the use of virtual machine 814.

Computing system 800 includes communication interface 802 that may be configured to communicate with application volumes 830. Communication interface 802 may communicate using Internet Small Computer Interface (iSCSI), Fibre Channel, Time Division Multiplex (TDM), asynchronous transfer mode (ATM), Internet Protocol (IP), Ethernet, synchronous optical networking (SONET), hybrid fiber-coax (HFC), circuit-switched, communication signaling, wireless communications, or some other communication format. Although illustrated separate from computing system 800 it should be understood that application volumes 830 may reside wholly or partially within computing system 800.

Referring still to FIG. 8, processing system 804 can comprise a microprocessor and other circuitry that retrieves and executes software 812 from storage system 810. Processing system 804 can be implemented within a single processing device, but can also be distributed across multiple processing devices or sub-systems that cooperate in executing program instructions. Examples of processing system 804 include general-purpose central processing units, application specific processors, and logic devices, as well as any other type of processing device, combinations of processing devices, or variations thereof.

Storage system 810 can comprise any storage media readable by processing system 804, and capable of storing software 812. Storage system 810 can include volatile and nonvolatile, removable and non-removable media implemented in any method or technology for storage of information, such as computer readable instructions, data structures, program modules, or other data. Storage system 810 can be implemented as a single storage device but may also be implemented across multiple storage devices or sub-systems. Storage system 810 can comprise additional elements, such as a controller, capable of communicating with processing system 804.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

User interface 806 can include a mouse, a keyboard, a camera, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in user interface 806. In some examples, user interface 806 may be omitted.

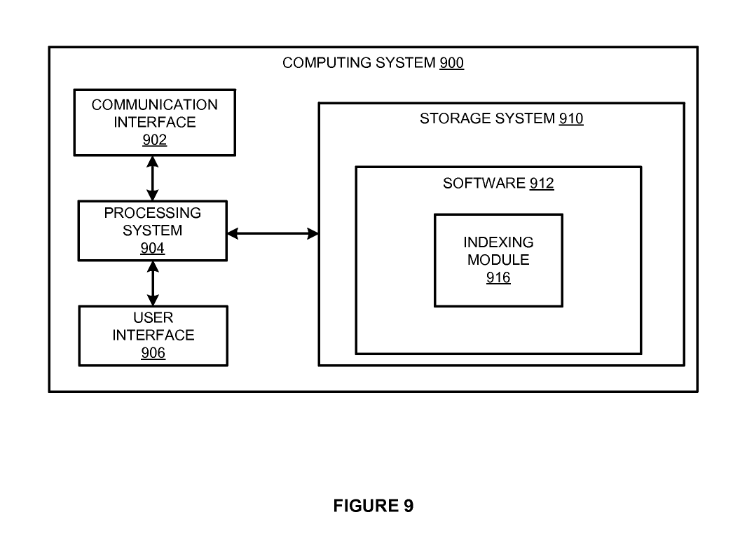

FIG. 9 illustrates a computing system 900 for generating and implementing an application index. Computing system 900 is an example of administration system 710, although other examples are possible. Computing system 900 includes communication interface 902, processing system 904, user interface 906, storage system 910, and software 912. Processing system 904 loads and executes software 912 from storage system 910. Software 912 includes indexing module 916. Software 912 may further include an operating system, utilities, drivers, network interfaces, applications, or some other type of software. When executed by computing system 900, software 912 directs processing system 904 to generate an application index as described herein.

In a particular example, indexing module 916 is used to generate an application index that can assist in the attachment of applications to various computing systems. Specifically, indexing module 916 may identify one or more applications that are stored within one or more attachable storage volumes, and identify storage locations for the one or more applications stored in the one or more attachable storage volumes. Further, indexing module 916 may generate an application index, wherein the application index comprises a data structure configured to associate identifiers for the one or more applications to the storage locations for the one or more applications.

In some examples, the generation of the application index may be done on the attachable computing systems. Accordingly, once generated, the computing system may identify one or more applications to attach, and use the application index to assist in identifying the locations of the appropriate storage volumes. In other instances, the indexing of the applications may occur within an administration system that distributes the application index to other attachable computing systems. Once distributed, the computing systems may use the application index to identify storage locations of applications necessary for execution on the computing systems.

Referring still to FIG. 9, processing system 904 can comprise a microprocessor and other circuitry that retrieves and executes software 912 from storage system 910. Processing system 904 can be implemented within a single processing device but can also be distributed across multiple processing devices or sub-systems that cooperate in executing program instructions. Examples of processing system 904 include general-purpose central processing units, application specific processors, and logic devices, as well as any other type of processing device, combinations of processing devices, or variations thereof.

Storage system 910 can comprise any storage media readable by processing system 904, and capable of storing software 912. Storage system 910 can include volatile and nonvolatile, removable and non-removable media implemented in any method or technology for storage of information, such as computer readable instructions, data structures, program modules, or other data. Storage system 910 can be implemented as a single storage device but may also be implemented across multiple storage devices or sub-systems. Storage system 910 can comprise additional elements, such as a controller, capable of communicating with processing system 904.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. It should be understood that in no case is the storage media a propagated signal.

User interface 906 can include a mouse, a keyboard, a camera, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in user interface 906. In some examples, user interface 906 may be omitted.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method of attaching an application to a computing system, the method comprising:
in a processing system, identifying an application attach triggering event for the computing system;
identifying a storage location for the application based on the application attach triggering event and an application index; and
attaching at least one storage volume to the computing system corresponding to the storage location.

2. The method of claim 1 wherein the computing system comprises a physical computing system.

3. The method of claim 2 wherein attaching the at least one storage volume to the computing system comprises mounting the at least one storage volume to the computing system.

4. The method of claim 1 wherein the computing system comprises a virtual machine.

5. The method of claim 4 wherein attaching the at least one storage volume to the computing system comprises mounting the at least one storage volume to the computing system via a hypervisor, the hypervisor configured to execute the virtual machine.

6. The method of claim 1 further comprising:
making the application available for execution on the computing system, wherein making the application available for execution comprises overlaying elements for the application within a file system for the computing system.

7. The method of claim 1 wherein identifying the application attach triggering event comprises receiving a user application selection on the computing system.

8. The method of claim 1 wherein identifying the application attach triggering event comprises receiving a command from an administrator to attach the application to the computing system.

9. A computer apparatus to attach an application to an attachable computing system, the computer apparatus comprising:
processing instructions that direct a computing system, when executed by the computing system, to:
identify an application attach triggering event for the attachable computing system;
identify a storage location for the application based on the application attach triggering event and an application index; and
attach at least one storage volume to the attachable computing system corresponding to the storage location; and
one or more non-transitory computer readable media that store the processing instructions.

10. The computer apparatus of claim 9 wherein the attachable computing system comprises a physical computing system.

11. The computer apparatus of claim 10 wherein the processing instructions to attach the at least one storage volume to the attachable computing system direct the computing system to mount the at least one storage volume to the attachable computing system.

12. The computer apparatus of claim 9 wherein the attachable computing system comprises a virtual machine.

13. The computer apparatus of claim 12 wherein the processing instructions to attach the at least one storage volume to the attachable computing system direct the computing system to mount the at least one storage volume to the attachable computing system via a hypervisor, the hypervisor configured to execute the virtual machine.

14. The computer apparatus of claim 9 wherein the processing instructions further direct the computing system to:
make the application available for execution on the attachable computing system, wherein making the application available for execution comprises overlaying elements for the application within a file system for the attachable computing system.

15. The computer apparatus of claim 9 wherein the processing instructions to identify the application attach triggering event direct the computing system to receive a user application selection on the attachable computing system.

16. The computer apparatus of claim 9 wherein the processing instructions to identify the application attach triggering event direct the computing system to receive a command from an administrator on an administration system to attach the application to the attachable computing system.

17. A computer apparatus to manage an application index, the computer apparatus comprising:
processing instructions that direct a computing system, when executed by the computing system, to:
identify one or more applications stored in one or more attachable storage volumes;
identify storage locations for the one or more applications stored in the one or more attachable storage volumes; and
generate the application index, the application index comprising a data structure configured to associate identifiers for the one or more applications to the storage locations for the one or more applications; and
one or more non-transitory computer readable media that store the processing instructions.

18. The computer apparatus of claim 17 wherein the processing instructions further direct the computing system to:
distribute the application index to one or more attachable computing systems.

19. The computer apparatus of claim 18 wherein the one or more attachable computing systems comprise one or more virtual machines.

20. The computer apparatus of claim 18 wherein the one or more attachable computing systems comprise one or more physical computing systems.
